(19) United States
(12) Patent Application Publication
(10) Pub. No.: US 2018/0343880 A1
(43) Pub. Date: Dec. 6, 2018

(54) Method and System for Manufacturing Mineral-Reduced Micellar Casin Concentrate

(71) Applicant: South Dakota Board of Regents, Pierre, SD (US)

(72) Inventor: Lloyd Metzger, Bruce, SD (US)

(21) Appl. No.: 15/775,762

(22) PCT Filed: Nov. 18, 2016
(86) PCT No.: PCT/US16/62899

§ 371 Date: May 11, 2018

Related U.S. Application Data
(60) Provisional application No. 62/257,260, filed on Nov. 19, 2015.

(51) Int. Cl. A23C 9/142; A23C 9/152; A23J 3/10

(52) U.S. Cl. CPC A23C 9/1422; A23J 3/10; A23C 9/1524

(57) ABSTRACT

A method for forming a modified micellar casein concentrate includes providing a volume of skim milk. The method further includes performing a first filtration process on the volume of skim milk to form a micellar casein concentrate. The method includes mixing carbon dioxide with at least a portion of the micellar casein concentrate to solubilize one or more components of the micellar casein concentrate. The method includes performing an additional filtration process on the mixture of carbon dioxide and micellar casein concentrate to remove at least a portion of the one or more solubilized components of the micellar casein concentrate to form a modified micellar casein concentrate.

### TECHNICAL FIELD

The present invention generally relates to the field of dairy product manufacture, and, in particular, to a method and system for manufacturing mineral-reduced micellar casein concentrate and related dairy products.

### BACKGROUND

Membrane filtration has been used extensively by the dairy industry to produce a variety of dairy ingredients from milk. Such dairy ingredients include micellar casein concentrate (MCC). Liquid or powder MCC manufactured from freshly pasteurized milk can be directly consumed or as a supplement to fortify and enhance nutritional qualities in processed food products. Membrane filtration has been effective at increasing the amount of MCC in a final food product, while simultaneously decreasing the amount of lactose in the final food product. However, milk contains many minerals including, but not limited to, calcium (Ca), phosphorus (P), potassium (K), magnesium (Mg), sodium (Na), chloride (Cl), and other minerals in low concentrations. Therefore, it would be desirable to provide a method and system that cures the deficiencies of prior approaches identified above.

### SUMMARY

A method for forming a modified micellar casein concentrate is disclosed, in accordance with one or more embodiments of the present disclosure. In one embodiment, the method includes providing a volume of skim milk. In another embodiment, the method includes performing a first filtration process on the volume of skim milk to form a micellar casein concentrate. In another embodiment, the method includes mixing carbon dioxide with at least a portion of the micellar casein concentrate to solubilize one or more components of the micellar casein concentrate. In another embodiment, the method includes performing an additional filtration process on the mixture of carbon dioxide and micellar casein concentrate to remove at least a portion of the one or more solubilized components of the micellar casein concentrate to form a modified micellar casein concentrate.

A method for forming a fat modified micellar casein concentrate is disclosed, in accordance with one or more embodiments of the present disclosure. In one embodiment, the method includes providing a volume of skim milk. In another embodiment, the method includes performing a first filtration process on the volume of skim milk to form a micellar casein concentrate. In another embodiment, the method includes providing a fat source. In another embodiment, the method includes mixing carbon dioxide with at least a portion of the micellar casein concentrate to solubilize one or more components of the micellar casein concentrate. In another embodiment, the method includes performing an additional filtration process on the mixture of carbon dioxide, micellar casein concentrate, and a fat from the fat source to remove at least a portion of the one or more solubilized components of the micellar casein concentrate to form a fat modified micellar casein concentrate.

A method for forming a fat modified micellar casein concentrate is disclosed, in accordance with one or more embodiments of the present disclosure. In one embodiment, the method includes providing a volume of skim milk. In another embodiment, the method includes performing a first filtration process on the volume of skim milk to form a micellar casein concentrate. In another embodiment, the method includes mixing carbon dioxide with at least a portion of the micellar casein concentrate to solubilize one or more components of the micellar casein concentrate. In another embodiment, the method includes performing an additional first filtration process on the mixture of carbon dioxide and micellar casein concentrate to remove at least a portion of the one or more solubilized components of the micellar casein concentrate to form a modified micellar casein concentrate. In another embodiment, the method includes providing a fat source. In another embodiment, the method includes mixing a fat from the fat source with at least a portion of the modified micellar casein concentrate to form a fat modified micellar casein concentrate.

A system for forming a modified micellar casein concentrate is disclosed, in accordance with one or more embodiments of the present disclosure. In one embodiment, the system includes a skim milk source. In another embodiment, the system includes, a first filter unit operatively coupled to the skim milk source and configured to perform a first filtration process on at least a portion of the mixture of skim milk to form a micellar casein concentrate. In another embodiment, the system includes, a carbon dioxide source fluidically coupled to the first filter unit and configured to inject carbon dioxide into the micellar casein concentrate to form a mixture of micellar casein concentrate and carbon dioxide. In another embodiment, the system includes, an additional filter unit configured to perform an additional filtration process on at least a portion of the mixture of micellar casein concentrate and carbon dioxide to remove at least a portion of one or more solubilized components of the micellar casein concentrate to form a modified micellar casein concentrate.

A system for forming a fat modified micellar casein concentrate is disclosed, in accordance with one or more embodiments of the present disclosure. In one embodiment, the system includes a skim milk source. In another embodiment, the system includes a first filter unit operatively coupled to the skim milk source and configured to perform a first filtration process on at least a portion of the mixture of skim milk to form a micellar casein concentrate. In another embodiment, the system includes a fat source. In another embodiment, the system includes a carbon dioxide source fluidically coupled to the first filter unit and configured to inject carbon dioxide into the micellar casein concentrate to form a mixture of micellar casein concentrate, carbon dioxide and fat. In another embodiment, the system includes an additional filter unit configured to perform an additional filtration process on at least a portion of the mixture of micellar casein concentrate, carbon dioxide, and fat to remove at least a portion of one or more solubilized components of the micellar casein concentrate to form a fat modified micellar casein concentrate.

A modified micellar casein concentrate prepared by a process is disclosed, in accordance with one or more embodiments of the present disclosure. In one embodiment, the modified micellar casein concentrate prepared by a process includes providing a volume of skim milk. In another embodiment, the modified micellar casein concentrate prepared by a process includes performing a first filtration process on the volume of skim milk to form a micellar casein concentrate. In another embodiment, the modified micellar casein concentrate prepared by a process includes mixing carbon dioxide with at least a portion of the micellar casein concentrate to solubilize one or more components of the micellar casein concentrate. In another embodiment, the modified micellar casein concentrate prepared by a process includes performing an additional filtration process on the mixture of carbon dioxide and micellar casein concentrate to remove at least a portion of the one or more solubilized components of the micellar casein concentrate to form a modified micellar casein concentrate.

A fat modified micellar casein concentrate prepared by a process is disclosed, in accordance with one or more embodiments of the present disclosure. In one embodiment, the fat modified micellar casein concentrate prepared by a process includes providing a volume of skim milk. In another embodiment, the fat modified micellar casein concentrate prepared by a process includes performing a first filtration process on the volume of skim milk to form a micellar casein concentrate. In another embodiment, the fat modified micellar casein concentrate prepared by a process includes providing a fat source. In another embodiment, the fat modified micellar casein concentrate prepared by a process includes mixing carbon dioxide with at least a portion of the micellar casein concentrate to solubilize one or more components of the micellar casein concentrate. In another embodiment, the fat modified micellar casein concentrate prepared by a process includes performing an additional filtration process on the mixture of carbon dioxide, micellar casein concentrate, and a fat from the fat source to remove at least a portion of the one or more solubilized components of the micellar casein concentrate to form a fat modified micellar casein concentrate.

A fat modified micellar casein concentrate prepared by a process is disclosed, in accordance with one or more embodiments of the present disclosure. In one embodiment, the fat modified micellar casein concentrate prepared by a process includes providing a volume of skim milk. In another embodiment, the fat modified micellar casein concentrate prepared by a process includes performing a first filtration process on the volume of skim milk to form a micellar casein concentrate. In another embodiment, the fat modified micellar casein concentrate prepared by a process includes mixing carbon dioxide with at least a portion of the micellar casein concentrate to solubilize one or more components of the micellar casein concentrate. In another embodiment, the fat modified micellar casein concentrate prepared by a process includes performing an additional first filtration process on the mixture of carbon dioxide and micellar casein concentrate to remove at least a portion of the one or more solubilized components of the micellar casein concentrate to form a modified micellar casein concentrate. In another embodiment, the fat modified micellar casein concentrate prepared by a process includes providing a fat source. In another embodiment, the fat modified micellar casein concentrate prepared by a process includes mixing a fat from the fat source with at least a portion of the modified micellar casein concentrate to form a fat modified micellar casein concentrate.

The foregoing is a summary and thus may contain simplifications, generalizations, inclusions, and/or omissions of detail; consequently, those skilled in the art will appreciate that the summary is illustrative only and is not intended to be in any way limiting. Other aspects, features, and advantages of the systems, products and/or methods and/or other subject matter described herein will become apparent in the teachings set forth herein. The accompanying drawings, which are incorporated in and constitute a part of the specification, illustrate embodiments of the disclosure and together with the general description, serve to explain the principles of the invention.

### BRIEF DESCRIPTION OF THE DRAWINGS

The numerous advantages of the disclosure may be better understood by those skilled in the art by reference to the accompanying figures in which:

FIGS. 1A-1H illustrates a block diagram view of a system for manufacturing a mineral-reduced micellar casein concentrate (MCC), in accordance with one or more embodiments of the present disclosure;

FIG. 2 illustrates a flow diagram depicting a method of manufacturing a mineral-reduced MCC, in accordance with one or more embodiments of the present disclosure;

FIG. 3 illustrates a flow diagram depicting a method of manufacturing a fat-modified mineral-reduced MCC, in accordance with one or more embodiments of the present disclosure; and

FIG. 4 illustrates a flow diagram depicting a method of manufacturing a fat-modified mineral-reduced MCC, in accordance with one or more embodiments of the present disclosure.

### DETAILED DESCRIPTION OF THE INVENTION

Reference will now be made in detail to the subject matter disclosed, which is illustrated in the accompanying drawings.

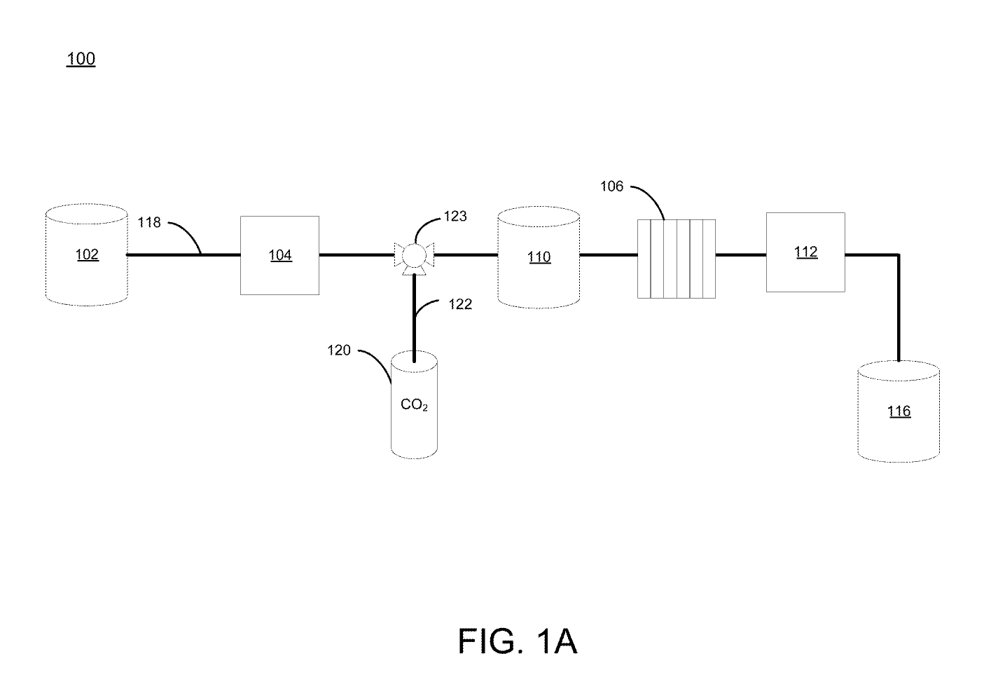

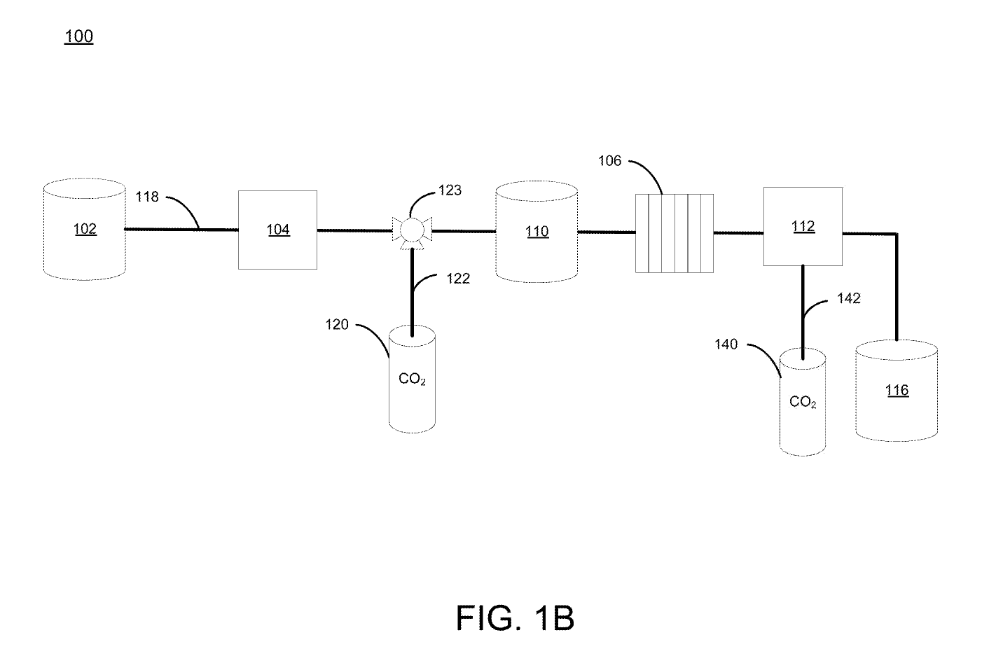

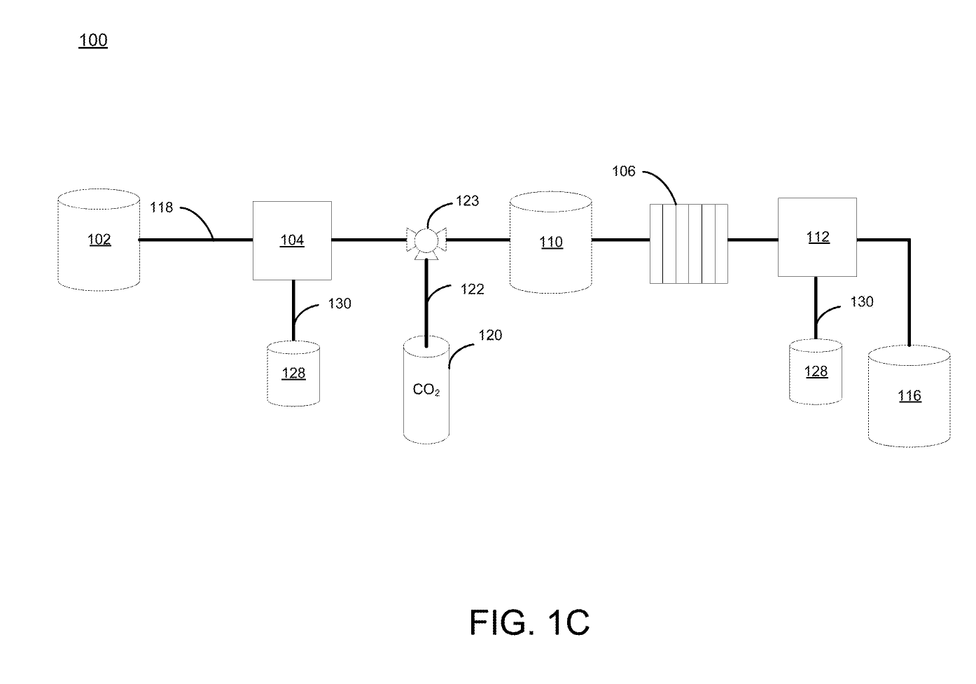

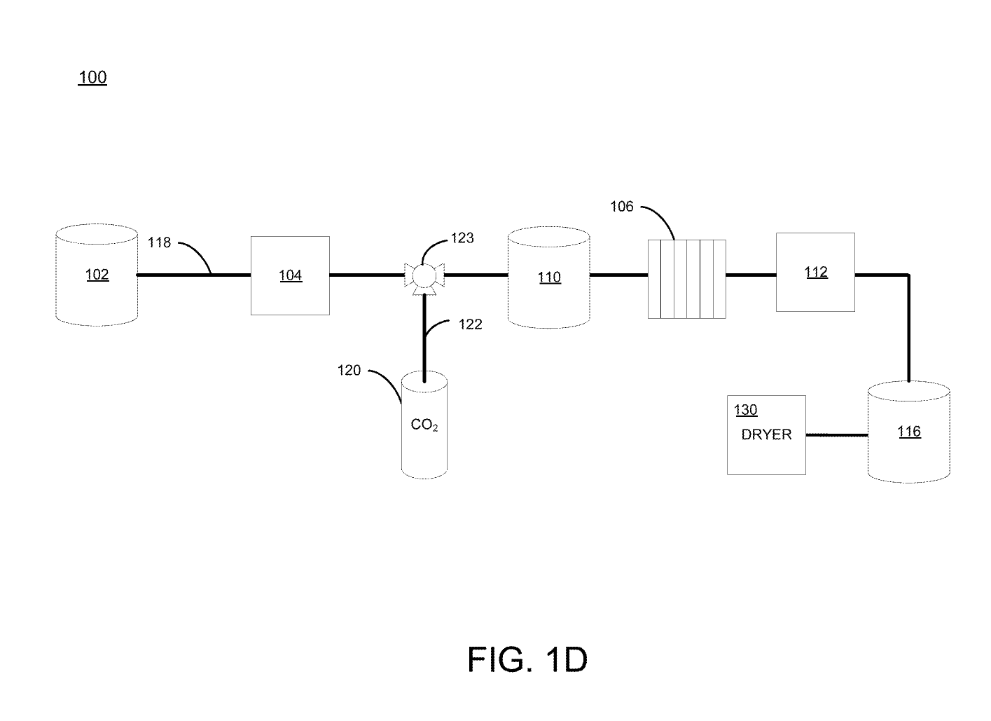

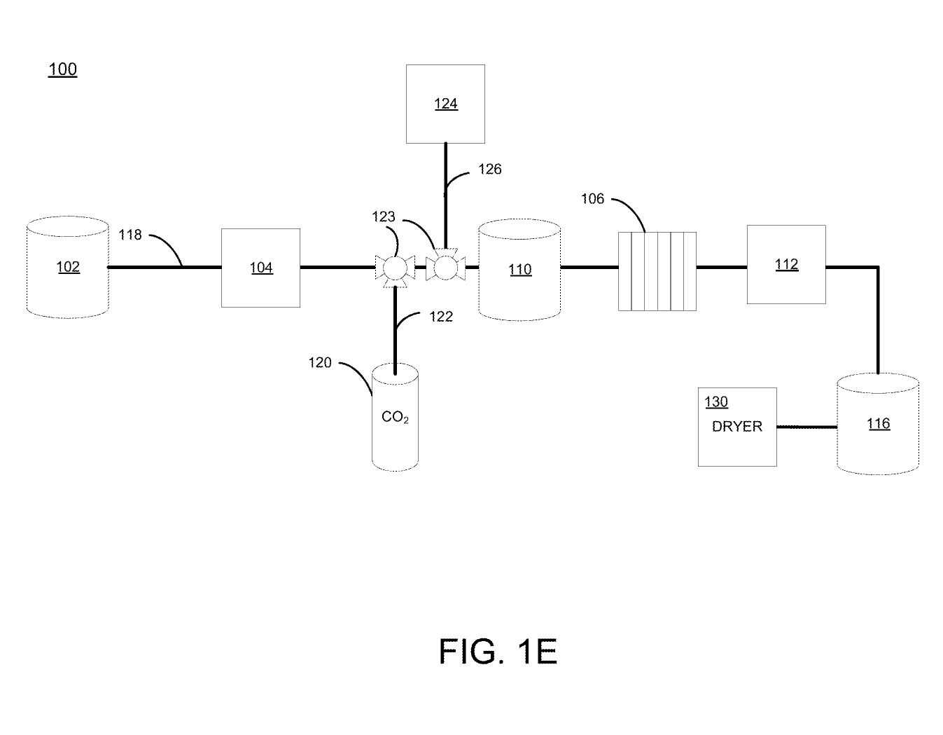

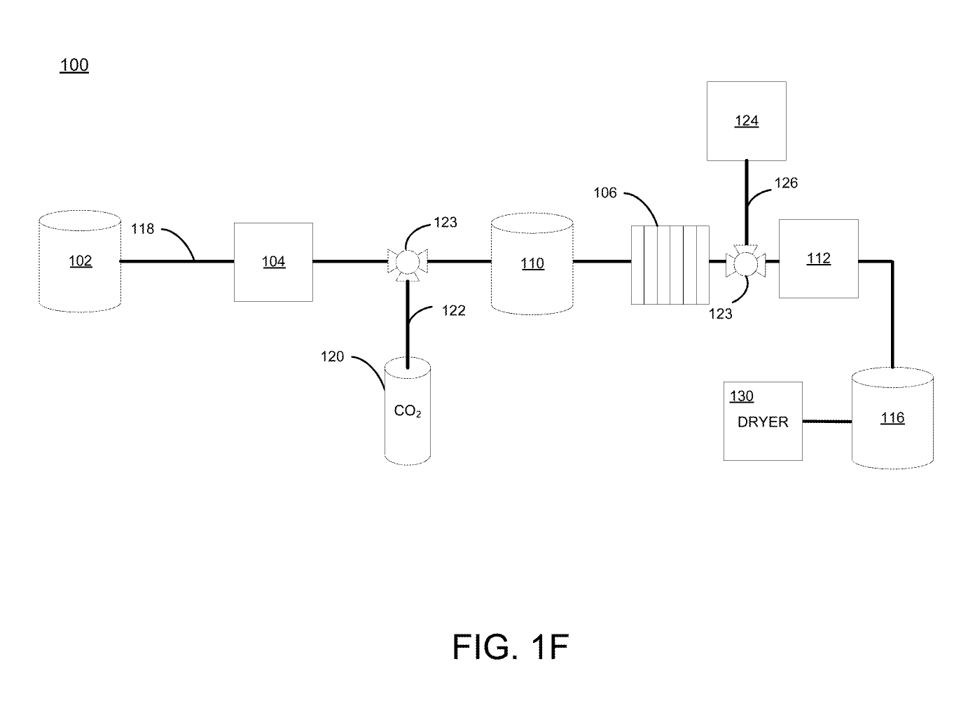

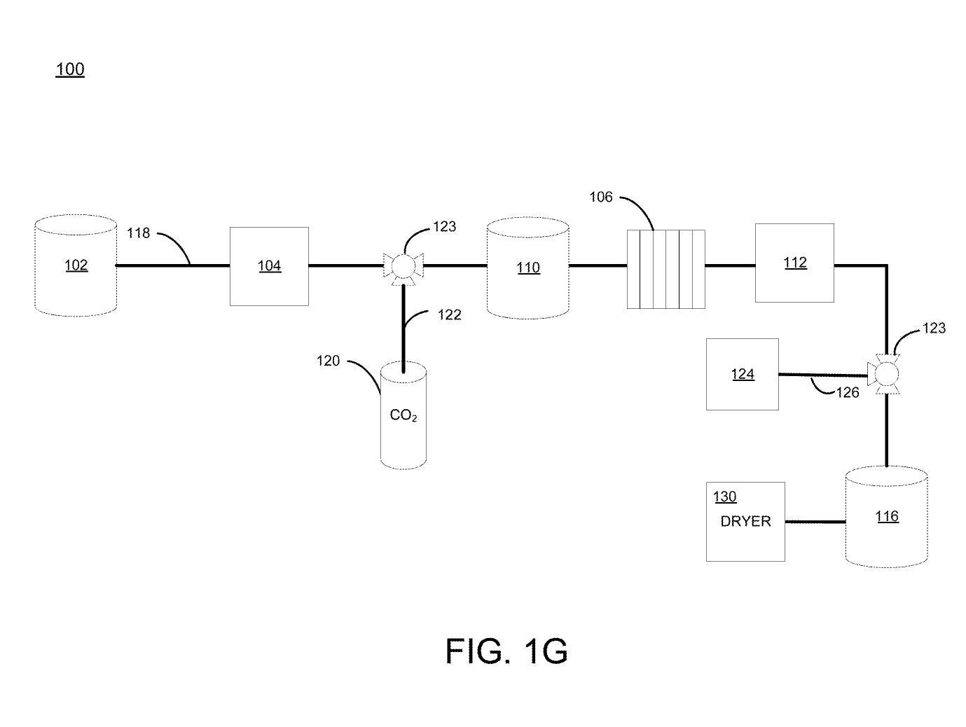

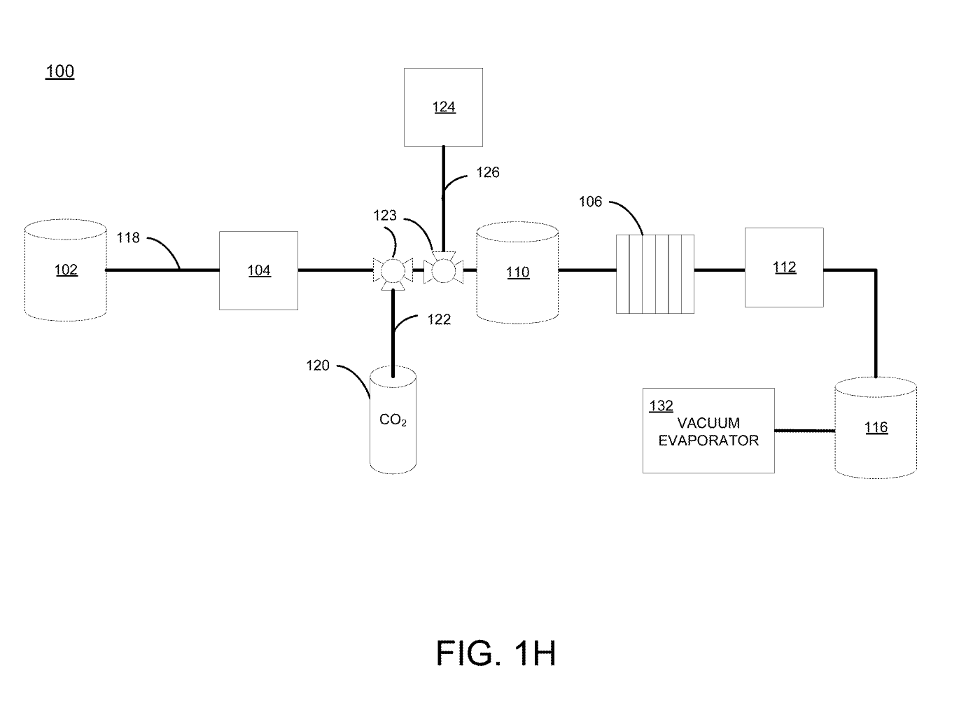

Referring generally to FIGS. 1A-4, a method and system for manufacturing a modified micellar casein concentrate (MCC) is disclosed, in accordance with one or more embodiments of the present disclosure.

Embodiments of the present disclosure are directed to the manufacture of MCC via the fractionation of skim milk into casein-rich retentate (i.e., MCC), and whey protein rich permeate using membrane microfiltration (MF) and/or diafiltration (DF). Additionally, MCC produced during microfiltration may be further processed with membrane ultrafiltration (UF) and/or DF to further adjust the MCC composition. The retentate formed from ultrafiltration can be used as a liquid, or may be spray-dried into a powder for long-term storage.

It is noted that liquid or powder MCC made from fresh pasteurized skim milk can be consumed as is, or may be used in processed food products to fortify and enhance nutritional qualities. Casein concentrates (e.g., MCC) derived from membrane filtration can be used as substitutes for traditional caseinates already widely used in many ready-to-eat functional food products. The clean flavor of MCC compared to caseinates means that they have potential for widespread use. Because membrane fractionation is used to manufacture MCC, the composition of MCC may be altered, and even tailored, depending on its final use requirements. Many functional and processed food manufacturers seek enhanced functionality “clean label” alternatives to currently used ingredients, which may turn away would be consumers. One way to enhance or alter the functionality of MCC is to modify the mineral salt content using membrane filtration, DF, and/or pH modification.

Embodiments of the present disclosure are directed to change the distribution of minerals and individual proteins between the colloidal and serum phases in milk by altering milks native environment, including pH, temperature, and/or ionic atmosphere. For example, as discussed further herein, decreasing milk pH from 6.75 to 6.00 (i.e., acidification) redistributes Ca, P, and casein proteins from the colloidal to serum phase. Embodiments of the present disclosure utilize this relationship between pH and mineral distribution of milk to modify the manufacture of MCC to change its end functionality.

Embodiments of the present disclosure are directed to reducing mineral content in MCC, while retaining a high level of protein (e.g., casein) in the MCC. Embodiments of the present disclosure may achieve a mineral reduction of 5-40% in a mineral-reduced MCC compared to typical membrane filtration approaches.

FIGS. 1A-1H illustrate a system 100 for manufacturing a modified micellar casein concentrate (MCC), in accordance with one or more embodiments of the present disclosure.

Referring now to FIG. 1A, in one embodiment, the system 100 includes a milk source 102, a first filter unit 104 and an additional filter unit 112. The milk source 102 (e.g., one or more milk tanks) is suitable for storing and providing a selected volume of milk. For example, the milk source 102 may be one or more milk tanks configured to store and provide a selected volume of milk. It is noted that the milk source 102 is not limited to one or more milk tanks and it is contemplated herein that alternative milk source devices may be implemented within the context of the system 100.

In another embodiment, the milk source 102 maintains the volume of milk at or within a selected set of preparation parameters. For example, the milk source 102 may maintain the milk at an initial pH in the range of 6.0 to 8.5. For instance, the milk source 102 may maintain the milk at an initial pH in the range of 6.7-6.8. In another embodiment, the milk source 102 maintains the milk at a selected temperature. For example, the milk source 102 may maintain the milk at a temperature between 15° C. and 100° C. For instance, the milk source 102 may maintain the milk at a temperature between 25° C. and 80° C.

Further, the milk source 102 may provide, via a valve unit, the prepared milk to a processing line 118 connected to a first filter unit 104 of the system 100. For example, the milk source 102 may provide pasteurized milk to the process line 118 that connects to the first filter unit 104 of the system 100.

In another embodiment, the milk source 102 maintains the volume of milk within a selected temperature before transfer to the processing line 118 connected to the first filter unit 104 of the system 100. For example, the milk source 102 may maintain the milk at a temperature between 1.0° C. and 20° C. More specifically, the milk source 102 may maintain the milk at a temperature between 1.0° C. and 7.2° C. Further, the cooled milk in the milk source 102 may be warmed via a heat exchanger and stored in a balance tank before transfer to the first filter unit 104.

As used throughout the present disclosure, the term “milk” is generally interpreted to extend to skim milk and milk containing fat in the range of 0.01 to 10.0%. It is noted that the initial milk of the present disclosure contains various ingredients including, but not limited to, casein proteins, whey proteins, fat, lactose, minerals (ash), and/or water. It is contemplated that embodiments of the present disclosure may be configured to utilize whole milk as an initial milk to form a mineral-reduced MCC. It is further noted that a fat addition from a fat source 124 described thereinafter in FIG. 1E of the present disclosure may not be necessary when whole milk is used as an initial milk source 102.

As used throughout the present disclosure, the term “ash” is generally defined as the total content of minerals present within a food. As used throughout the present disclosure, the term “casein” is generally defined by a family of related phosphoproteins in milk. For example, casein may commonly be found in mammalian milk. For instance, casein may make up to 80% of the proteins in cow milk and between 20% and 45% of the proteins in human milk. Also, as used throughout the present disclosure, the term “micellar casein” or “casein micelle” is generally defined by a suspension of casein in milk. As used throughout the present disclosure, the term “micellar casein concentrate (MCC)” is generally defined by having more than 90.0% casein as a percent of the true protein. The true protein may include casein, serum whey, and the like. Table 1 below provides components of pasteurized skim milk prior to filtration.

TABLE 1
Composition of Pasteurized Skim Milk

| component | % (wt/wt) |
|---|---|
| Total solids | 9.33 |
| Protein | 3.40 |
| Casein | 2.70 |
| Whey | 0.70 |
| Fat | 0.07 |
| Lactose | 4.80 |
| Mineral (ash) | 0.72 |
| Calcium (Ca) | 0.15 |
| Total nitrogen (TN) | 3.62 |
| Protein:ash | 4.72 |

In one embodiment, the first filter unit 104 may include, but is not limited to, a microfiltration (MF) unit 104. In this regard, the first filter unit 104 is arranged to receive an output of the milk source 102. For example, the first filter unit 104 may be placed in fluidic communication with the milk source 102 via the processing line 118. In this regard, the MF unit 104 may receive the milk and apply a first filtration process. As used throughout the present disclosure, the term “microfiltration (MF)” is generally defined by a filtration process that fractionates skim milk into a casein-rich retentate (i.e., MCC) and a whey protein rich permeate.

The first filter unit 104 may implement any microfiltration technology known in the art, such as, but not limited to, cross-flow filtration (i.e., tangential filtration) or dead end filtration. In one embodiment, the first filter unit 104 includes a microfiltration membrane. For example, the microfiltration membrane of the first filter unit 104 may be formed from one or more polymer materials having a selected pore size (or range in pore size). For instance, the microfiltration membrane of the first filter unit 104 may include, but is not limited to, a polymeric spiral-wound filtration membrane having a pore size between 0.01 and 2.00 μm. Further, the microfiltration membrane of the first filter unit 104 may include, but is not limited to, a polymeric spiral-wound filtration membrane having a pore size between 0.1 and 1.00 μm.

By way of another example, the microfiltration membrane of the first filter unit 104 may be formed from one or more ceramic materials having a selected pore size. For instance, the microfiltration membrane of the first filter unit 104 may include, but is not limited to, a tubular ceramic filtration membrane having a pore size between 0.01 and 2.00 μm. Further, the microfiltration membrane of the first filter unit 104 may include, but is not limited to, a tubular ceramic filtration membrane having a pore size between 0.1 and 1.00 μm.

In another embodiment, the first filter unit 104 may perform a microfiltration process on the milk provided from the milk source 102 at a selected milk temperature range. For example, the first filter unit 104 may perform the microfiltration process on the milk having a temperature in the range of 5° C. to 90° C. For instance, the first filter unit 104 using a polymeric spiral-wound filtration membrane may perform the microfiltration process on the milk at a temperature in the range of 5° C. to 50° C. More specifically, the first filter unit 104 using the polymeric spiral-wound filtration membrane may perform the microfiltration process on the milk having a temperature in the range of 10° C. to 35° C. By way of another example, the first filter unit 104 using a tubular ceramic filtration membrane may perform the microfiltration process on the milk at a temperature in the range of 30° C. to 90° C. More specifically, the first filter unit 104 using a tubular ceramic filtration membrane may perform the microfiltration process on the milk at a temperature in the range of 50° C. to 70° C.

It is noted that the microfiltration membrane of the first filter unit 104 may be formed from any material known in the art and is not limited to a polymer or ceramic membrane, which are provided merely for illustrative purposes. For example, the microfiltration membrane may be formed from sintered metal, porous alumina, and the like.

The microfiltration process performed by the first filter unit 104 may separate casein proteins from whey proteins in the milk provided from the milk source 102 to form a micellar casein concentrate (MCC). It is noted herein that the casein proteins are larger than the whey proteins so that the casein proteins are unable to permeate the membrane pores of the microfiltration membrane of the first filter unit 104, whereas smaller whey proteins are able to permeate the membrane pores of the microfiltration membrane of the first filter unit 104. In this regard, the casein proteins are retained in the system 100 as retentate, while the whey proteins are obtained as permeate. Lactose and minerals are retained together with the casein proteins during the microfiltration process performed by the first filter unit 104 and continue flowing via the processing line 118 of the system 100 for further processing.

In another embodiment, the MCC may be formed so as to have a selected concentration range of casein. For example, the first filter unit 104 may apply the microfiltration process so as to achieve a casein concentration between 2.00% and 15.00% (wt/wt). More specifically, the concentration range of casein obtained after the microfiltration process may be between 4.21% and 10.53% (wt/wt). In another embodiment, the MCC may be formed so as to have a selected concentration range of minerals (ash). For example, the first filter unit 104 may apply the microfiltration process so as to achieve a mineral (ash) concentration between 0.01% and 1.00%. More specifically, the concentration range of minerals (ash) obtained after the microfiltration process performed by the first filter unit 104 may be between 0.28% and 0.70%. In another embodiment, the MCC may be formed so as to have a selected ratio of protein (e.g., casein and serum) to mineral (ash). For example, the first filter unit 104 may apply the microfiltration process so as to achieve a ratio of protein to minerals between 5.50 and 7.50. More specifically, the ratio of protein (e.g., casein and serum) to mineral (ash) after the microfiltration process performed by the first filter unit 104 may be between 6.40 and 6.95.

In another embodiment, the first filter unit 104 may apply the microfiltration process so as to achieve a selected concentration factor (CF) range. For example, the first filter unit 104 may apply the microfiltration process so as to achieve a CF between 1.0 and 8.0. More specifically, the CF of the microfiltration process performed by the first filter unit 104 may be between 2.5 and 5.0. As used throughout the present disclosure, the term “concentration factor (CF)” is generally defined by the degree that dissolved solids are concentrated in a liquid.

In another embodiment, the first filter unit 104 may apply the microfiltration process so as to achieve a selected DF quantity range. For example, the first filter unit 104 may apply the microfiltration process so as to achieve a diafiltration quantity between 10% and 400%. More specifically, the DF quantity of the microfiltration process performed by the first filter unit 104 may be between 25% and 300%. As used throughout the present disclosure, the term “diafiltration (DF) quantity” is generally defined by the percent of the original mass of a liquid.

Table 2 provided below lists illustrative component ranges of the MCC after the microfiltration process of the present disclosure is applied.

TABLE 2
Component Ranges of MCC After Microfiltration

| component | % (wt/wt) |
|---|---|
| Total solids | 7.26-18.15 |
| Protein | 4.49-11.23 |
| Casein | 4.21-10.53 |
| Whey | 0.28-0.70 |
| Fat | 0.11-0.27 |
| Lactose | 1.92-4.80 |
| Mineral (ash) | 0.65-1.63 |
| Total nitrogen (TN) | 4.58-11.45 |
| Protein:ash | 6.40-6.95 |

It is noted that the component ranges of Table 2 and the previous discussion are not to be interpreted as limitations on the scope of the present disclosure and are provided merely for illustrative purposes.

In one embodiment, the system 100 includes a first holding tank 110. For example, the first holding tank 110 may be placed in fluidic communication with the output of the first filter unit 104 via the processing line 118 and may be configured to receive the MCC from the first filter unit 104 and hold the MCC prior to filtration by the additional filter unit 112. It is noted that the holding tank 110 of the present disclosure may include any holding tank known in the art of dairy product production.

In one embodiment, the system 100 includes a carbon dioxide (CO₂) supply unit 120. The CO₂ supply unit 120 may be placed in fluidic communication with the processing line 118 of the system 100 via a CO₂ supply line 122. For example, the CO₂ supply unit 120 may provide, via a gas sparger, gaseous CO₂ directly into the MCC within the processing line 118.

The CO₂ supply unit 120 may inject CO₂ into the MCC so as to achieve a selected pH range in the MCC. For example, the CO₂ supply unit 120 may supply gaseous CO₂ directly into flowing MCC within the processing line 118 to achieve a selected pH in the MCC. By way of another example, the CO₂ supply unit 120 may supply gaseous CO₂ into the first holding tank 110 containing MCC to achieve a selected pH in the MCC. For instance, the CO₂ supply unit 120 may inject CO₂ into the MCC to achieve a pH in the MCC between approximately 4.50 and 7.50. More specifically, the CO₂ supply unit 120 may inject CO₂ into the MCC to achieve a pH in the MCC between approximately 5.70 and 6.50.

The CO₂ may be injected into the MCC at a selected pressure. For example, CO₂ may be injected into flowing MCC in the processing line 118 (or into the first holding tank 110) at a pressure between 10 kPa and 800 kPa. More specifically, CO₂ may be injected into flowing MCC in the processing line 118 at a pressure between 30 kPa and 700 kPa (e.g., 0 to 5 L/min).

In another embodiment, the MCC is mixed with the gaseous CO₂ until it equilibrates to form a CO₂-treated MCC. For example, the CO₂-treated MCC may be stirred for a selected time (e.g., 0.5 to 4 hours) to reach equilibrium. For instance, the CO₂-treated MCC may be stirred for approximately one hour to reach equilibrium. In another embodiment, the CO₂-treated MCC is maintained at a selected temperature in the first holding tank 110. For example, the CO₂-treated MCC may be maintained at a temperature between 1° C. and 10° C. in the first holding tank 110 during equilibration.

The CO₂ supply line 122 of the CO₂ supply unit 120 may include any gas supply device known in the art suitable for facilitating the injection of CO₂ into the MCC. For example, the CO₂ supply line 122 may include, but not limited to, a gas sparger (e.g., stainless steel sparger). The gas sparger of the supply line 122 may have a selected pore size. For example, the gas sparger of the supply line 122 may have a pore size between 1.0 μm and 15 μm. More specifically, the gas sparger may have a pore size between 2.0 μm and 10 μm. In another embodiment, the gas sparger may be implemented utilizing a selected back pressure. For example, the gas sparger may use a back pressure between 20 kPa and 500 kPa in order to provide adequate gaseous CO₂ into the flowing MCC in the processing line 118.

It is noted that decreasing pH of the MCC via the injection of gaseous CO₂ facilitates the solubilization of one or more minerals in the colloidal phase of the MCC. More specifically, decreasing the pH of the MCC facilitates a transfer of one or more minerals (e.g., a micellar calcium phosphate or the like) from a colloidal phase of the MCC to a serum phase of the MCC. As described further herein, in a subsequent ultrafiltration step, the solubilized minerals (e.g., a micellar calcium phosphate or the like) in the serum phase of the MCC permeate through the associated ultrafiltration membrane as permeate and leave behind the micellar casein as retentate.

It is noted that, while the present disclosure focuses on the acidification of the MCC via the injection of gaseous CO₂, such a configuration is not a limitation on the scope of the present disclosure. Rather, the scope of the present disclosure may be extended to the acidification of the MCC using any acidification method known in the art. For example, the acidification of the MCC of the present disclosure may be carried out using one or more organic acidulants. It is further noted that the use of gaseous CO₂ to acidify the MCC is particularly advantageous since it is easily removed from the treated MCC following the CO₂-injection step. For example, residual CO₂ contained within the treated MCC may be easily removed from the MCC by heating or application of vacuum in subsequent steps of the manufacturing process. As a result, the acidification of the MCC using CO₂ injection aids in producing an unfavorable taste in a dairy food product formed with the MCC.

The injection of carbon dioxide into milk to manufacture modified milk protein concentrate is generally described by Chenchalah Marella et al. in Manufacture of modified milk protein concentrate utilizing injection of carbon dioxide, J. Dairy Sci, Issue 98, pp. 3577-3589 (2014), which is incorporated herein by reference in the entirety. The injection of carbon dioxide into milk to manufacture modified milk protein concentrate is also described in U.S. patent application Ser. No. 14/876,798, filed on Oct. 6, 2015, which is incorporated herein by reference in the entirety. The injection of carbon dioxide into milk to manufacture modified milk protein concentrate is also described in U.S. patent application Ser. No. 14/616,952, filed on Feb. 9, 2015, which is incorporated herein by reference in the entirety.

In one embodiment, the system 100 includes a heat exchanger 106. The heat exchanger 106 may be placed in fluidic communication with the output of the first holding tank 110. For example, the heat exchanger 106 may receive the CO₂-treated MCC from the first holding tank 110 via the processing line 118. The heat exchanger 106 of the system 100 may be used to heat and/or cool the milk, the MCC, and/or the CO₂-treated MCC at various steps throughout the manufacturing process.

In another embodiment, the system 100 includes two or more heat exchangers 106, whereby a first heat exchanger is used to heat the milk, the MCC, and/or the CO₂-treated MCC, while a second heat exchanger is used to cool the milk, the MCC, and/or the CO₂-treated MCC.

In another embodiment, the system 100 includes one or more heating units. The one or more heating units are configured to heat the milk, the MCC, and/or the CO₂-treated MCC so as to apply a heat treatment to the milk, the MCC, and/or the CO₂-treated MCC. The heating unit may include any one or more heating devices known in the art. In one embodiment, the system 100 may include a dedicated heating tank equipped with one or more heaters suitable for heating the milk, the MCC, and/or the CO₂-treated MCC. In another embodiment, any one of the processing components of the system 100 may be equipped with one or more heaters capable of carrying out the heat treatment in the present disclosure.

In another embodiment, the system 100 includes one or more cooling units. The one or more cooling units are configured to cool the milk, the MCC, and/or the CO₂-treated MCC so as to apply a cooling treatment to the milk, the MCC, and/or the CO₂-treated MCC. The cooling unit may include any one or more cooling devices known in the art of dairy product manufacture. In one embodiment, the system 100 may include a dedicated cooling tank equipped with one or more coolers suitable for cooling the milk, the MCC, and/or the CO₂-treated MCC. In another embodiment, any one of the processing components of the system 100 may be equipped with one or more coolers capable of carrying out the cooling treatment in the present disclosure.

It is contemplated that, while the location of the heat exchanger 106 is depicted as being immediately after the first holding tank 110, as shown in FIGS. 1A-1H, such a configuration is provided merely for illustrative purposes. The heat exchanger 106 of the present disclosure may be located at various positions throughout system 100 to heat and/or cool a given process liquid (e.g., milk, MCC, CO₂-treated MCC, mineral-reduced MCC mixture, and/or the like).

In one embodiment, the additional filter unit 112 may include, but is not limited to, an ultrafiltration (UF) unit. Further, the additional filter unit 112 may be arranged to receive an output of the first holding tank 110. In this regard, after CO₂-treatment of the MCC (and, optionally, storage of the MCC in the first holding tank 110), the UF unit 112 may receive the CO₂-treated MCC and apply an additional filtration process.

In another embodiment, the additional filter unit 112 may be placed in fluidic communication with the first filter unit 104 via the processing line 118. For example, the additional filter unit 112 may receive the CO₂-treated MCC directly from an output of the first filter unit 104. In this embodiment, it is noted that the CO₂-treated MCC need not be held in a holding tank to allow for equilibration.

In another embodiment, the additional filtration unit 112 may receive the CO₂-treated MCC after cooling or heating by the heat exchanger 106.

In the case where the additional filter unit 112 is an ultrafiltration unit, the additional filter unit 112 may implement any ultrafiltration technology known in the art, such as, but not limited to, cross-flow filtration (i.e., tangential filtration) or dead-end filtration. As used throughout the present disclosure, the term “ultrafiltration (UF)” is generally defined by a filtration process that fractionates a mixture of casein, lactose, and minerals into a casein-rich retentate (i.e., a mineral-reduced MCC) and a lactose-mineral permeate.

In another embodiment, the additional filter unit 112 includes an ultrafiltration membrane. The ultrafiltration membrane of the additional filter unit 112 may be formed from any material known in the art of ultrafiltration such as, but not limited to, one or more polymer materials or one or more ceramic materials. For example, the ultrafiltration membrane of the additional filter unit 112 may include, but is not limited to, a polymeric spiral-wound filtration membrane or a tubular ceramic filtration membrane. In another embodiment, the ultrafiltration membrane of the additional filter unit 112 may have a selected molecular weight cutoff. As used throughout the present disclosure, the term “molecular weight cutoff” is generally defined as a lowest molecular weight (in Daltons) at which greater than 90% of a solute with a known molecular weight is retained by a membrane. For instance, the ultrafiltration membrane may include, but is not limited to, an ultrafiltration membrane having a molecular weight cutoff between 1 kDa and 30 kDa. More specifically, the ultrafiltration membrane may include, but is not limited to, an ultrafiltration membrane having a molecular weight cutoff between 5 kDa and 20 kDa.

It is noted that the ultrafiltration membrane of the additional filter unit 112 may be formed from any material known in the art and is not limited to a polymer or ceramic membrane, which are provided above merely for illustrative purposes. For example, the ultrafiltration membrane may be formed from sintered metal, porous alumina, and the like.

In another embodiment, the additional filter unit 112 may perform an ultrafiltration process on the MCC provided from the output of the first holding tank 110 at a selected MCC temperature range. For example, the additional filter unit 112 may perform the ultrafiltration process on the MCC at a temperature in the range of 10° C. to 90° C. More specifically, the additional filter unit 112 using a polymeric spiral-wound filtration membrane may perform the ultrafiltration process on the MCC at a temperature in the range of 10° C. to 35° C. By way of another example, additional filter unit 112 using a tubular ceramic filtration membrane may perform the ultrafiltration process on the MCC at a temperature in the range of 50° C. to 70° C.

The ultrafiltration process performed by the additional filter unit 112 may separate casein proteins from the minerals in the CO₂-treated MCC. It is noted that casein proteins are larger than minerals so that the casein proteins are unable to permeate the membrane pores of the ultrafiltration membrane of the additional filter unit 112, whereas smaller minerals are able to permeate the membrane pores of the ultrafiltration membrane of the additional filter unit 112. In this regard, the casein proteins are retained in the system 100 as retentate, while the minerals are obtained as permeate. Lactose permeates along with the minerals from the ultrafiltration process performed by the additional filter unit 112. In this regard, the retentate from the ultrafiltration process performed by the additional filter unit 112 contains mostly the casein proteins.

In another embodiment, the additional filter unit 112 may apply the ultrafiltration process so as to achieve a selected CF range. For example, the additional filter unit 112 may apply the ultrafiltration process so as to achieve a CF between 0.5 and 15.0. More specifically, the CF of the ultrafiltration process performed by the additional filter unit 112 may be between 1.1 and 10.0.

In another embodiment, the additional filter unit 112 may apply the ultrafiltration process so as to achieve a selected DF quantity range. For example, the additional filter unit 112 may apply the ultrafiltration process so as to achieve a diafiltration quantity between 0% and 500%. More specifically, the DF quantity of the ultrafiltration process performed by the additional filter unit 112 may be between 0% and 300%.

In another embodiment, the mineral-reduced MCC may be formed so as to have a selected concentration range of casein. For example, the additional filter unit 112 may apply the ultrafiltration process so as to achieve a casein concentration range between 10.00% and 25.00% (wt/wt). More specifically, the concentration range of casein obtained after the ultrafiltration may be between 15.89% and 19.51% (wt/wt).

In another embodiment, the mineral-reduced MCC may be formed so as to have a selected concentration range of minerals (ash). For example, the additional filter unit 112 may apply the ultrafiltration process so as to achieve a mineral (ash) concentration between 0.50% and 2.00% (wt/wt). More specifically, the concentration range of minerals (ash) obtained after the ultrafiltration may be between 1.12% and 1.40% (wt/wt).

In another embodiment, the mineral-reduced MCC may be formed so as to have a selected ratio of protein (e.g., casein and serum) to mineral (ash). For example, the additional filter unit 112 may apply the ultrafiltration process so as to achieve a ratio of protein to minerals between 8.00 and 15.00. More specifically, the ratio of protein (e.g., casein and serum) to mineral (ash) after the ultrafiltration process performed by the additional filter unit 112 may be between 10.50 and 13.05.

Table 3 provided below lists a comparison of concentration ranges of the MCC components obtained after the ultrafiltration process of the present disclosure with and without CO₂ injection.

TABLE 3
Comparison Table of MCC Component Ranges after
Ultrafiltration with and without CO₂ Injection

| | No CO₂ | |
|---|---|---|
| component | injection % (wt/wt) | CO₂ injection % (wt/wt) |
| Total solids | 20.40-24.95 | 19.95-24.50 |
| Total protein | 17.12-20.95 | 16.95-20.82 |
| casein | 16.05-19.64 | 15.89-19.51 |
| Serum | 16.05-19.64 | 1.12-1.40 |
| Fat | 0.25-0.50 | 0.23-0.50 |
| Lactose | ≤4.80 | ≤4.80 |
| Mineral (ash) | 1.65-2.1 | 1.30-1.90 |
| Total nitrogen (TN) | 17.19-21.05 | 17.17-21.09 |
| Protein:ash | 9.90-10.25 | 10.50-13.05 |

It is noted that the component ranges of Table 3 and the previous discussion are not to be interpreted as limitations on the scope of the present disclosure and are provided merely for illustrative purposes.

In one embodiment, the system 100 includes a second holding tank 116. The second holding tank 116 may include any holding tank known in the art capable of receiving a mineral-reduced MCC. In one embodiment, the second holding tank 116 may be placed in fluidic communication with the output of the additional filter unit 112 via the processing line 118 and is configured to receive the mineral-reduced MCC from the additional filter unit 112. For example, the second holding tank 116 may store the mineral-reduced MCC as a liquid for later use. By way of another example, the mineral-reduced MCC in the second holding tank 116 may be dried into powder form for long-term storage.

In another embodiment, pH of the mineral-reduced MCC from the output of the additional filter unit 112 is adjusted. For example, pH of the mineral-reduced MCC from the output of the additional filter unit 112 may be adjusted using one or more base solutions. For instance, the one or more base solutions may include, but are not limited to, sodium hydroxide (NaOH) solution, potassium hydroxide (KOH) solution, and/or the like. It is noted that pH adjustment of the mineral-reduced MCC from the output of the additional filter unit 112 may be performed within the processing line 118 connected to the second holding tank 116 or within the second holding tank 116.

The system 100 may include any number of additional components necessary to carry out the manufacture steps of the present disclosure. In one embodiment, the system 100 may include one or more pumps. In this regard, the one or more pumps serve to aid in transporting liquid product between any of the components (e.g., milk source 102, first filter unit 104, first holding tank 110, heat exchanger 106, additional filter unit 112, valve unit 123, and second holding tank 116) along the processing line 118 of the system 100. The one or more pumps may include any pumps known in the art. For example, the one or more pumps may include, but are not limited to, one or more displacement pumps (e.g., positive displacement pump) or one or more centrifugal pumps.

In another embodiment, the system 100 includes one or more valve units 123. The one or more valve units 123 may serve to selectively fluidically couple two or more of the sub-systems or components of system 100. For example, one or more valve units 123 may be placed between two or more of the milk source 102, the first filter unit 104, the first holding tank 110, the additional filter unit 112, the heat exchanger 106, the second holding tank 116, and the carbon dioxide supply unit 120. In one embodiment, the one or more valve units 123 are controlled manually. In another embodiment, the one or more valve units 123 are controlled automatically via the controller. In another embodiment, the controller includes one or more processors. In another embodiment, program instructions, when executed by the one or more processors, are configured to open and/or close one or more of the pathways associated with the one or more valve units 123 in order to carry out one or more of the process steps of the present disclosure.

The one or more valve units 123 of system 100 may include any type of valve unit known in the art. For example, the one or more valve units 123 may include, but are not limited to, one or more three-way valves. By way of another example, the one or more valve units 123 may include, but are not limited to, a set of two-way valves fluidically coupled via a T-junction. It is noted that the above examples are not limitations on the present disclosure and are provided merely for illustrative purposes. The placement and use of one or more valve units is described in U.S. patent application Ser. No. 14/616,952, filed on Feb. 9, 2015, which is incorporated by reference above in the entirety.

Referring now to FIG. 1B, in one embodiment, the system 100 includes a second carbon dioxide (CO₂) supply unit 140 and a second CO₂ supply line 142. It is noted herein that the embodiments and components described previously herein with respect to the CO₂ supply unit 120 and the CO₂ supply line 122 should be interpreted to extend to the second CO₂ supply unit 140 and the second CO₂ supply line 142.

In one embodiment, the second CO₂ supply unit 140 may be placed in fluidic communication with the additional filter unit 112 via the second CO₂ supply line 142. For example, as shown in FIG. 1B, the additional filter unit 112 may receive the CO₂-treated MCC from the output of the first holding tank 110 via the heat exchanger 106 while the second CO₂ supply unit 140 supplies extra gaseous CO₂ to the CO₂-treated MCC in the additional filter unit 112 via the second CO₂ supply line 142. In this regard, the second CO₂ supply unit 140 serves to further mix the CO₂-treated MCC with additional gaseous CO₂ to maintain and further reduce the pH of the CO₂-treated MCC. The addition of additional CO₂ further facilitates the transformation of the minerals of the CO₂-treated MCC from the colloidal phase of the CO₂-treated MCC to the serum phase of the CO₂-treated MCC, which allows for a further reduction of the minerals in the mineral-reduced MCC via the ultrafiltration process performed by the additional filter unit 112. As shown in FIGS. 1A and 1B, the gaseous CO₂ can be injected before and/or during the ultrafiltration process performed by the additional filter unit 112 to reduce the pH of the MCC and/or the CO₂-treated MCC, respectively.

It is contemplated that, while two different CO₂ sources 120 and 140 are depicted in FIG. 1B to provide carbon dioxide at two different locations along the process line 118, such a configuration is merely provided for illustrative purposes. The present disclosure may be configured to provide carbon dioxide at any number of locations along the process line 118 of system 100.

Referring now to FIG. 1C, in an alternative and/or additional embodiment, the system 100 is configured for manufacturing a mineral-reduced MCC using a diafiltration step. As used throughout the present disclosure, the term “diafiltration (DF)” is generally defined by a process of a water addition to a product during MF and/or UF and a subsequent removal of the water. For example, the DF may remove additional lactose and soluble salts present in a MCC and/or a CO₂-treated MCC, thereby increasing the relative concentration of casein proteins to total solids. It is noted herein that the embodiments and examples of FIGS. 1A and 1B should be interpreted to extend to the embodiment of FIG. 1C, unless otherwise noted.

In one embodiment, the system 100 shown in FIG. 1C may further include a water supply unit 128 for containing and providing a water source to the system 100. The water supply unit 128 may be placed in fluidic communication with the first filter unit 104 via a water supply line 130. In this regard, the system 100 may further purify the MCC within the first filter unit 104 by washing the MCC using the water from the water supply unit 128 and subsequently removing the water used for the DF process from the first filter unit 104. The water supply unit 128 may include any device known in the art capable of containing a water source. For example, the water supply unit 128 may include, but is not limited to, a tank, a vessel, bin, container or the like. The water source contained in the water supply unit 128 may include any water suitable for use in dairy manufacture (e.g., distilled water, filtered water, softened water, and/or the like).

In another embodiment, the system 100 may then add a required amount of water to a recirculating loop of the first filter unit 104. In turn, the system 100 may perform the microfiltration process of the first filter unit 104 to remove additional whey proteins as permeate to form a final MCC. It is noted that the final MCC using a DF step after the microfiltration process performed by the first filter unit 104 may have lower whey protein content than that without the DF process.

In another embodiment, the system 100 shown in FIG. 1C is also configured for manufacturing a mineral-reduced MCC using a DF step at the additional filter unit 112. For example, embodiments depicted in FIG. 1C may supply a water source from the water supply unit 128 via a water supply line 130 to the additional filter unit 112 containing the CO₂-treated MCC provided from the output of the first holding tank 110. The added water may facilitate a removal of additional lactose and solubilized minerals in the CO₂-treated MCC. In this regard, a final modified MCC using the DF step after the ultrafiltration process performed by the additional filter unit 112 may have lower mineral and lactose contents than that without the DF process. It is contemplated that, while the DF process described above is depicted to be applied individually to the first filter unit 104 or the additional filter unit 112 of the system 100, such a configuration is provided merely for illustrative purposes. It is noted that the DF process may be applied at the first filter unit 104 as well as the additional filter unit 112 at the same time.

Referring now to FIG. 1D, in one embodiment, the system 100 is further configured for manufacturing a mineral-reduced MCC. For example, the embodiment depicted in FIG. 1D may be directed to form a powdered mineral-reduced MCC. It is noted herein that the embodiments and examples of FIGS. 1A-1C should be interpreted to extend to the embodiment of FIG. 1D, unless otherwise noted.

In one embodiment, the system 100 includes a dryer 130. The dryer 130 may be placed in fluidic communication with the second holding tank 116 via the processing line 118. The second holding tank 116 may contain the mineral-reduced MCC. For example, the mineral-reduced MCC may be dried by the dryer 130 to form a powdered mineral-reduced MCC for long-term storage. By way of another example, the drying the mineral-reduced MCC may include a spray dried method known in the art, such as, but is not limited to, a single-stage pilot-scale dryer fitted with a centrifugal disc atomizer.

In another embodiment, the powdered mineral-reduced MCC may be formed so as to have a selected moisture range. For example, the dryer 130 may apply the drying process so as to provide a powdered mineral-reduced MCC having moisture content between 1.0% and 10.0%. More specifically, the moisture range of the powdered mineral-reduced MCC may be between 3.0% and 6.0%. It is noted that the dryer 130 shown in FIG. 1D may be utilized in the systems 100 shown in FIGS. 1B and 1C to form the corresponding powdered mineral-reduced MCCs.

Referring now to FIG. 1E, in one embodiment, the system 100 is further configured for manufacturing a fat-modified mineral-reduced MCC. For example, the embodiment depicted in FIG. 1E may be used to form a powdered fat-modified mineral-reduced MCC. It is noted herein that the embodiments and examples of FIGS. 1A-1D should be interpreted to extend to the embodiment of FIG. 1E, unless otherwise noted.

In one embodiment, the system 100 may further include a fat supply unit 124 for containing and providing a fat supply source. The fat supply unit 124 may be placed in fluidic communication with the processing line 118 connected to the first holding tank 110 via a fat supply line 126. In this regard, the system 100 may tailor the mineral and/or fat profile of the MCC product by controlling the content of minerals from the CO₂-treated MCC by performing the ultrafiltration process of the additional filter unit 112 and the amount of fat from the fat supply unit 124. The fat supply unit 124 may include any device known in the art capable of containing a fat source. For example, the fat supply unit 124 may include, but is not limited to, a tank, a vessel, bin, container and the like. In another embodiment, the fat source contained in the fat supply unit 124 includes any fat source suitable for use in dairy manufacture (e.g., fat sources suitable for quark cheese production). For example, the fat source may include a dairy fat source, such as, but not limited to, cream, butter and/or butter oil. By way of another example, the fat source may include a non-dairy fat source, such as, but not limited to, vegetable oil, hydrogenated oil, polyunsaturated fatty acids (PUFA), or monounsaturated fatty acids (MUFA).

In another embodiment, the system 100 includes a homogenizer source coupled to the first holding tank 110. In this embodiment, the system 100 may supply homogenizer to the first holding tank 110 and the fat source from the fat supply unit 124. The homogenizer may serve to homogenize the CO₂-treated MCC and the fat source together.

In one embodiment, the system 100 is configured to add a selected amount of fat source (e.g., cream) to the CO₂-treated MCC directly into the processing line 118 connected to the first holding tank 110. In turn, the system 100 may homogenize the fat-modified CO₂-treated MCC using a homogenizer (e.g., two stage homogenizer). In another embodiment, the system 100 may add a required amount of fat source (e.g., cream) to the CO₂-treated MCC directly into the first holding tank 110.

In another embodiment, the heat exchanger may apply a heating and/or cooling process to the fat-modified CO₂-treated MCC. For example, following homogenization, the heat exchanger may heat and/or cool the fat-modified CO₂-treated MCC to the selected temperature prior to the ultrafiltration process performed by the additional filter unit 112. By way of another example, the heat exchanger may be an inline heat exchanger.

In another embodiment, the fat-modified CO₂-treated MCC is transferred to the additional filter unit 112 for filtering the solubilized minerals in the serum phase of the fat-modified CO₂-treated MCC. For example, the added fat and the existing MCC may be retained as retentate, while the solubilized minerals may be collected as permeate. In this regard, after the ultrafiltration process performed by the additional filter unit 112 on the fat-modified CO₂-treated MCC, a fat-modified mineral-reduced MCC may be formed.

In another embodiment, the second holding tank 116 may store the fat-modified mineral-reduced MCC as a liquid for later use. By way of another example, the fat-modified mineral-reduced MCC in the second holding tank 116 may be dried by the dryer 130 to form a powdered fat-modified mineral-reduced MCC for long-term storage. For instance, the drying the fat-modified mineral-reduced MCC may include a spray dried method known in the art, such as, but not limited to, a single-stage pilot-scale dryer fitted with a centrifugal disc atomizer. In another embodiment, the fat-modified mineral-reduced MCC may be further concentrated by any liquid concentration method known in the art to form a concentrated fat-modified mineral-reduced MCC as a liquid.

It is noted that the fat addition from the fat source 124 may not be necessary when whole milk (or milk having sufficient initial fat content) is used as an initial milk source 102.

Referring now to FIGS. 1F and 1G, in one embodiment, the system 100 is configured for manufacturing a fat-modified mineral-reduced MCC. For example, embodiments depicted in FIG. 1F may supply a fat source from the fat supply unit 124 to the processing line 118 to mix with the CO₂-treated MCC provided from the heat exchanger 106 prior to the additional filter unit 112. The added fat may be retained along with the MCC in the colloidal phase and the solubilized minerals in the serum phase may be collected as permeate.

In another embodiment, the system 100 depicted in FIG. 1G may supply a fat source from the fat supply unit 124 into the processing line 118 to mix with the mineral-reduced MCC provided from the additional filter unit 112. The fat-modified mineral-reduced MCC may be utilized directly or dried into a powered form as described above. It is noted herein that the embodiments and examples of FIGS. 1A-1E should be interpreted to extend to the embodiment of FIGS. 1F and 1G, unless otherwise noted.

It is contemplated that, while a fat source from a fat supply unit 124 described above is shown as the only ingredient added to the system 100 to modify the mineral-reduced MCC products, such a configuration is merely provided for illustrative purposes. Other additional ingredients such as, but are not limited to, sugar and/or starch can be added to the system 100 in the similar manner described above. In this regard, any additional ingredients may be formulated to have a selected mineral and fat concentration.

Referring now to FIG. 1H, in one embodiment, the system 100 is further configured for manufacturing a cheese base from a fat-modified mineral-reduced MCC. For example, embodiments depicted in FIG. 1H may supply a fat source from the fat supply unit 124 into the processing line 118 connected to the first filter unit 104 and the first holding tank 110. The added fat may be retained along with the MCC in the colloidal phase and the solubilized minerals in the serum phase may be collected as permeate after the ultrafiltration process performed by the additional filter unit 112. The fat-modified mineral-reduced MCC may be kept in the second holding tank 116.

Further, the system 100 shown in FIG. 1H includes a vacuum evaporator 132. The vacuum evaporator 132 may be placed in fluidic communication with the output of the second holding tank 116. For example, the fat-modified mineral-reduced MCC may be concentrated by scrape surface vacuum evaporation to form a cheese base that can be utilized in process cheese manufacture. It is noted herein that the embodiments and examples of FIGS. 1A-1G should be interpreted to extend to the embodiment of FIG. 1H, unless otherwise noted. It is further noted that, while the vacuum evaporator 132 shown in FIG. 1H is utilized to process the fat-modified mineral-reduced MCC formed from the system 100 for manufacturing the cheese base, such a configuration is merely provided for illustrative purposes. The present disclosure may be configured to utilize the vacuum evaporator 132 for the system 100 shown in FIGS. 1F and 1G to manufacture a cheese base from the fat-modified mineral-reduced MCC.

It is noted that the mineral-reduced MCC formed by the system 100 shown in FIGS. 1A-1C may be further processed to make process cheese with less emulsifying salts. In general, the emulsifying salts are added to the process cheese in order to create an emulsion during a process cheese manufacturing. The emulsion created by the emulsifying salts is due to a unique function of the emulsifying salts to chelate minerals (e.g., calcium) in a colloidal phase in the MCC and then transfer the chelated minerals into a serum phase of the MCC. The system 100 of the present invention forms the mineral-reduced MCC by lowering the pH of the MCC which allows for a transfer of solubilized (i.e., chelated) minerals (e.g., calcium) from a colloidal phase to a serum phase. This is essentially the same function of the emulsifying salts that are necessary during the process cheese manufacturing. As a result, less emulsifying salts are required to make the process cheese with the mineral-reduced MCC formed by the system 100 described herein.

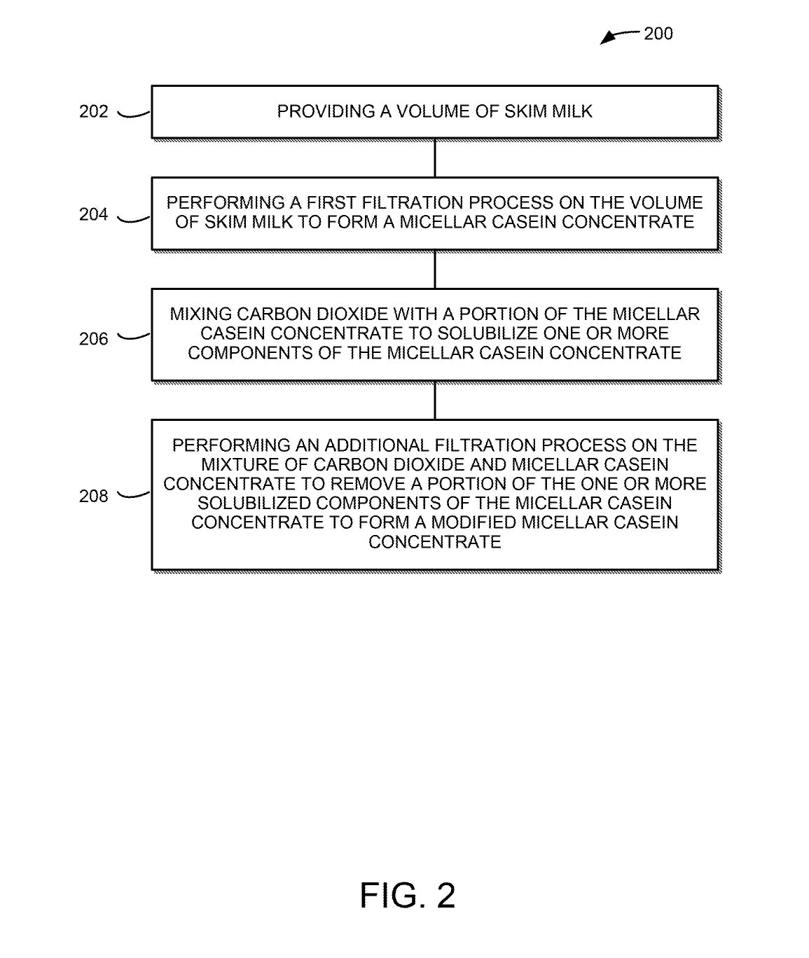

FIG. 2 illustrates a process flow diagram 200 depicting a method for manufacturing a mineral-reduced micellar casein concentrate (MCC), in accordance with one or more embodiments of the present disclosure. It is noted herein that the systems 100 as shown in FIGS. 1A, 1B, and 1D may carry out the various process steps of the flow diagram 200. It is further noted herein, however, that the process depicted in the flow diagram 200 is not limited to the architecture of the systems 100 as shown in FIGS. 1A, 1B, and 1D and it is recognized that additional analogous system-level architectures may be constructed to carry out all or a portion of the steps in the process flow diagram 200.

In step 202, a volume of skim milk is provided. In one embodiment, the volume of skim milk includes pasteurized skim milk. In another embodiment, the pasteurized skim milk is provided so as to have an initial selected pH. For example, the pasteurized skim milk may have an initial pH in the range of 6.0 to 8.5. For instance, the pasteurized skim milk may have an initial pH in the range of 6.7 to 7.8. In another embodiment, the pasteurized skim milk has a selected total protein content range. For example, the pasteurized skim milk may have total protein content in the range of 3.0% to 4.0% (wt/wt). For instance, the pasteurized skim milk may have total protein content in the range of 3.30% to 3.60% (wt/wt). In another embodiment, the pasteurized skim milk has a selected casein protein content range. For example, the pasteurized skim milk may have casein protein content in the range of 1.50% to 4.00% (wt/wt). For instance, the pasteurized skim milk may have casein protein content in the range of 2.60% to 2.80% (wt/wt). In another embodiment, the pasteurized skim milk has a selected whey protein content range. For example, the pasteurized skim milk may have whey protein content in the range of 0.20% to 1.50% (wt/wt). For instance, the pasteurized skim milk may have whey protein content in the range of 0.50% to 0.90% (wt/wt). In another embodiment, the pasteurized skim milk has an initial mineral (ash) content range. For example, the pasteurized skim milk may have mineral (ash) content in the range of 0.50% to 1.00% (wt/wt). By way of another example, the pasteurized skim milk may have mineral (ash) content in the range of 0.60% to 0.80% (wt/wt). For instance, the pasteurized skim milk may have calcium (Ca) content in the range of 0.05% to 0.30% (wt/wt). In another instance, the pasteurized skim milk may have calcium (Ca) content in the range of 0.10% to 0.20% (wt/wt).

In step 204, a first filtration process is performed on the volume of skim milk to form a micellar casein concentrate (MCC). For example, the first filtration process performed in this step may include, but is not limited to, a microfiltration process. By way of another example, the microfiltration process performed by the first filter unit 104, shown in FIGS. 1A-1H, may include, but is not limited to, a cross-flow filtration process (i.e., tangential flow filtration) or a dead-end filtration process. For instance, the first filter unit 104 may include any microfiltration membrane shapes and flow geometries known in the art including, but not limited to, a spiral-wound membrane or a tubular membrane. In another instance, the microfiltration membrane may be formed from any material known in the art capable of performing a microfiltration process including, but not limited to, one or more polymers and/or one or more ceramics.

In another embodiment, the microfiltration membrane may have various pore sizes. For example, the pore size of the microfiltration membrane may be between 0.01 μm and 2.00 μm. For instance, the pore size of the microfiltration membrane may be between 0.1 μm and 1.0 μm.

In another embodiment, after the microfiltration step 204, the MCC is cooled. For example, a heat exchanger may serve to cool the MCC to a temperature in the range of 1° C. to 10° C. In another embodiment, the MCC is cooled in a first holding tank 110 with an inline heat exchanger.

In step 206, carbon dioxide is mixed with at least a portion of the micellar casein concentrate to solubilize one or more components of the micellar casein concentrate. For example, a carbon dioxide supply unit 120 shown in FIGS. 1A-1H may supply gaseous CO₂ to the MCC. By way of another example, the gaseous CO₂ may be injected into the processing line 118 connected to the first filter unit 104 and the first holding tank 110. In another embodiment, the gaseous CO₂ may be directly injected into the first holding tank 110. In another embodiment, prior to the CO₂ mixing step 206, the MCC may be held for a selected period of time in the first holding tank 110.

In another embodiment, the MCC is mixed with the gaseous CO₂ until it equilibrates to form a CO₂-treated MCC. For example, the CO₂-treated MCC may be stirred for a selected time (e.g., 0.5 to 4 hours) to reach the equilibrium. For instance, the CO₂-treated MCC may be stirred for approximately one hour to reach equilibrium. In another embodiment, the CO₂-treated MCC is maintained at a selected temperature. For example, the CO₂-treated MCC may be maintained at a temperature between 1° C. and 10° C. during equilibration.

In another embodiment, following mixture of CO₂ with the MMC, the CO₂-treated MCC is held in the first holding tank 110 at a selected temperature. For example, the temperature of the first holding tank 110 may be maintained at a temperature between 1° C. and 10° C. during equilibration of CO₂-treated MCC mixture. It is noted that the temperature of the first holding tank 110 may be maintained and/or controlled using any manner known in the art, such as, but not limited to, one or more heat exchangers.

In another embodiment, the CO₂-treated MCC is maintained at a selected pH value. For example, the pH of the CO₂-treated MCC may be maintained between 4.00 and 7.00. For instance, the pH of the CO₂-treated MCC may be maintained between 5.70 and 6.50.

In another embodiment, the mixing carbon with at least a portion of the MCC to solubilize one or more components of the MCC includes transforming the one or more components of the MCC from a colloidal phase to a serum phase. For example, the one or more components of the MCC may include one or more minerals. By way of another example, the one or more minerals of the MCC may include calcium phosphate.

It is noted that a treatment of the MCC with gaseous CO₂ decreases pH of the MCC from approximately 6.75 to approximately 6.00, which transforms the one or more minerals of the MCC from the colloidal phase of the MCC to the serum phase of the MCC. The one or more minerals in the serum phase of the MCC are soluble, which allows for their removal in the ultrafiltration step 208.

In step 208, an additional filtration process is performed on the mixture of carbon dioxide and MCC to remove at least a portion of the one or more solubilized components of the MCC to form a modified MCC. For example, the additional filtration process performed in this step may include, but is not limited to, an ultrafiltration process. For instance, the ultrafiltration process performed by the additional filter unit 112 shown in FIGS. 1A-1H may include, but is not limited to, a cross-flow filtration (i.e., tangential flow filtration) or a dead-end filtration. For instance, the additional filter unit 112 may include any ultrafiltration membrane shapes and flow geometries known in the art, such as, but not limited to, a spiral-wound membrane or a tubular membrane. In another instance, the ultrafiltration membrane may be formed from any material known in the art capable of performing an ultrafiltration, such as, but not limited to, one or more polymers and/or one or more ceramics.

In another embodiment, the ultrafiltration membrane has a selected molecular weight cutoff range. For example, the ultrafiltration membrane may have molecular weight cutoff range of a 1 kDa to 30 kDa. For instance, the ultrafiltration membrane may have molecular weight cutoff range of a 5 kDa to 20 kDa.

In general, the solubilized minerals in the serum phase of the MCC may be collected as permeate of the ultrafiltration process and the remaining MCC in the colloidal phase of the MCC may be obtained as retentate of the ultrafiltration process. In this regard, the final mixture (i.e., the modified MCC or the retentate of the ultrafiltration) has lower mineral content.

In another embodiment, the modified MCC comprises a mineral-reduced MCC. For example, a mineral reduction range of the mineral-reduced MCC may be between 1% and 50%. For instance, a mineral reduction range of the mineral-reduced MCC may be between 5% and 40%.

In another embodiment, an additional filtration process is performed on the mixture of carbon dioxide and MCC while mixing additional carbon dioxide 140 shown in FIG. 1B with the mixture of carbon dioxide and MCC. For example, the additional carbon dioxide may be injected directly into the mixture of carbon dioxide and MCC recirculation loop of the additional filtration unit (i.e., additional filter unit 112) to maintain and further reduce pH of the mixture of carbon dioxide and MCC.

In another embodiment, the modified MCC is further processed to form a powdered modified MCC. For example, the modified MCC may be dried by a spray-dryer 130, shown in FIGS. 1D-1G, to form the powdered modified MCC to be utilized for fortifying and enhancing nutritional qualities of processed food products.

In another embodiment, the modified MCC is further processed to form a concentrated modified MCC. For example, the modified MCC may be further concentrated to form the concentrated modified MCC to be used for fortifying and enhancing nutritional qualities of processed food products.

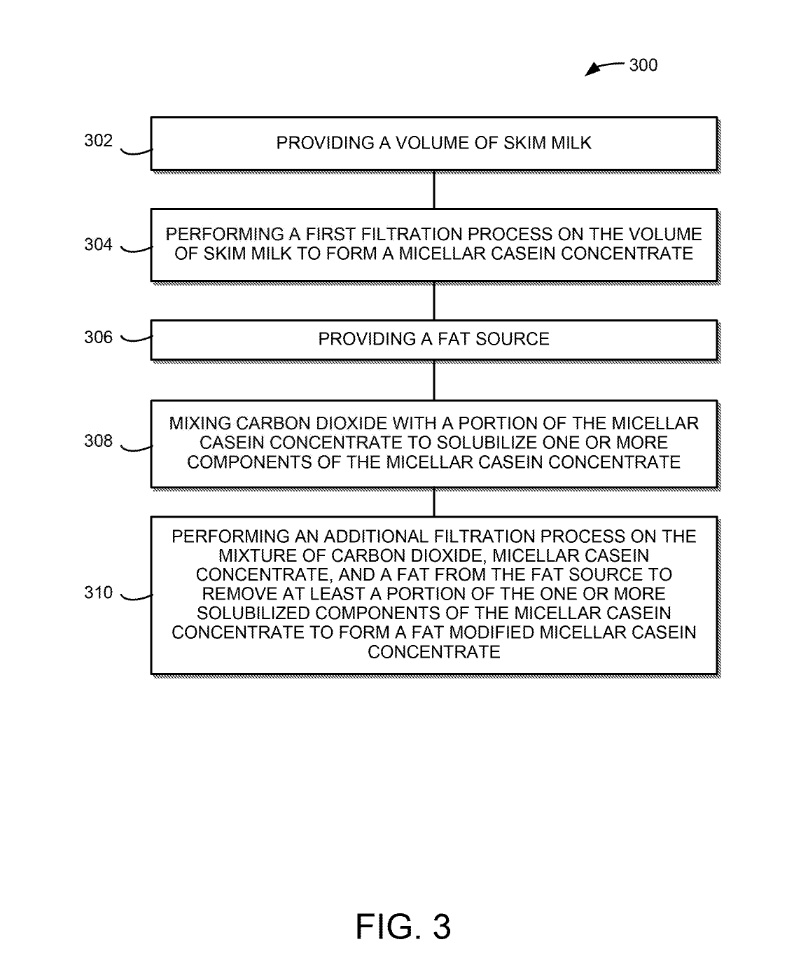

FIG. 3 illustrates a process flow diagram 300 depicting a method for manufacturing a fat-modified mineral-reduced MCC, in accordance with one or more embodiments of the present disclosure. For example, the process flow 300 may be used to form any fat-modified mineral-reduced MCC. It is noted herein that the systems 100 as shown in FIGS. 1E, 1F, and 1H may carry out the various process steps of the flow diagram 300. It is further noted herein, however, that the process depicted in the flow diagram 300 is not limited to the architecture of the systems 100 as shown in FIGS. 1E, 1F, and 1H and it is recognized that additional analogous system-level architectures may be constructed to carry out all or a portion of the steps in the process flow 300. It is further noted that the embodiments and examples of the process flow 200 should be interpreted to extend to the process flow 300, unless otherwise noted.

In step 302, a volume of skim milk is provided.

In step 304, a first filtration process on the volume of skim milk is performed to form a micellar casein concentrate (MCC).

In step 306, a fat source is provided.

The process flow 300 described herein may tailor the mineral and/or fat profile of the MCC by controlling the amount of carbon dioxide source (e.g., gaseous CO₂) from the carbon dioxide supply unit 120 and the amount of fat from the fat supply unit 124 shown in FIGS. 1E-1H, respectively. In one embodiment, a fat from the fat source 124, shown in FIG. 1E, is mixed prior to the step 308. The fat source contained in the fat supply unit 124, shown in FIG. 1E, may include any fat source suitable for use in dairy manufacture. For example, the fat source may include a dairy fat source, such as, but not limited to, cream, butter and/or butter oil. By way of another example, the fat source may include a non-dairy fat source, such as, but not limited to, vegetable oil, hydrogenated oil, polyunsaturated fatty acids (PUFA), or monounsaturated fatty acids (MUFA). In another embodiment, a fat from the fat source 124, shown in FIG. 1F, is mixed prior to the step 310.

In step 308, carbon dioxide is mixed with at least a portion of the MCC to solubilize one or more components of the MCC.

In step 310, an additional filtration process is performed on the mixture of carbon dioxide, MCC, and a fat from the fat source to remove at least a portion of the one or more solubilized components of the MCC to form a fat modified MCC.

Ii is noted that the solubilized minerals in the serum phase of the MCC may be collected as permeate of the ultrafiltration process at the additional filter unit 112 and the remaining MCC and the fat in the colloidal phase of the MCC may be obtained as retentate of the ultrafiltration. In this regard, the final product (i.e., the fat modified MCC or the retentate of the ultrafiltration) has lower mineral content.

In another embodiment, the fat modified MCC comprises a fat-modified mineral-reduced MCC. For example, a mineral reduction range of the fat-modified mineral-reduced MCC is between 1% and 50%. For instance, a mineral reduction range of the fat-modified mineral-reduced MCC is between 5% and 40%.

In another embodiment, an additional filtration process on the mixture of carbon dioxide, MCC, and a fat from the fat source is performed while mixing additional carbon dioxide with the mixture of carbon dioxide, MCC, and a fat. For example, the additional carbon dioxide may be injected directly into the mixture of carbon dioxide, MCC, and a fat recirculation loop of the additional filtration unit (i.e., an additional filter unit 112) to maintain and further reduce pH of the mixture of carbon dioxide, MCC, and a fat.

In another embodiment, the fat modified MCC is further processed to form a powdered fat modified MCC. For example, the fat modified MCC may be dried by a spray-dryer 130, shown in FIGS. 1E-1G, to form the powdered fat modified MCC to be utilized for fortifying and enhancing nutritional qualities of processed food products.

In another embodiment, the fat modified MCC is further processed to form a concentrated fat modified MCC. For example, the fat modified MCC may be concentrated to form the concentrated fat modified MCC concentrate to be used for fortifying and enhancing nutritional qualities of processed food products.

In another embodiment, the fat modified MCC is further processed to form a cheese base. For example, the fat modified MCC may be concentrated by scrape surface vacuum evaporation 132, shown in FIG. 1H, to form the cheese base that can be utilized in process cheese manufacture.

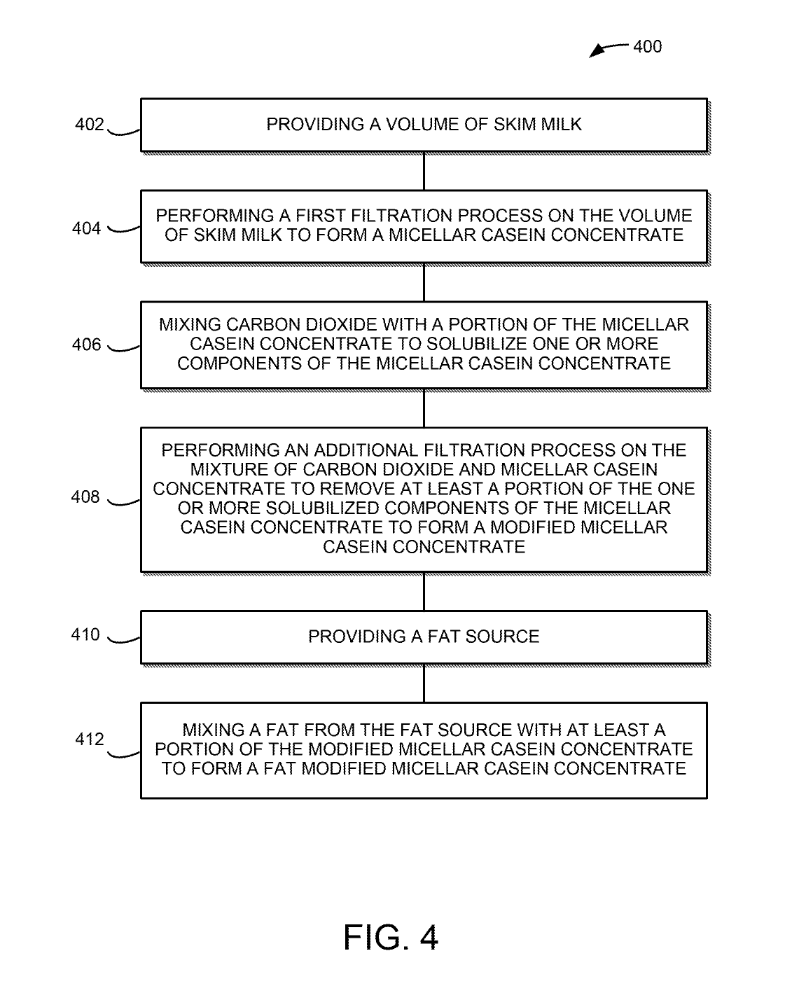

FIG. 4 illustrates a process flow diagram 400 depicting a method for manufacturing a fat modified micellar casein concentrate (MCC), in accordance with one or more embodiments of the present disclosure. It is noted herein that the system 100 as shown in FIG. 1G may carry out the various process steps of the flow diagram 400. It is further noted herein, however, that the process depicted in the flow diagram 400 is not limited to the architecture of the system 100 as shown in FIGS. 1G and 1t is recognized that additional analogous system-level architectures may be constructed to carry out all or a portion of the steps in the process flow diagram 400.

In step 402, a volume of skim milk is provided.

In step 404, a first filtration process on the volume of skim milk is performed to form a micellar casein concentrate (MCC).

In step 406, carbon dioxide is mixed with at least a portion of the MCC to solubilize one or more components of the MCC.

In step 408, an additional filtration process is performed on the mixture of carbon dioxide and MCC to remove at least a portion of the one or more solubilized components of the MCC to form a modified MCC.

In step 410, a fat source is provided. In one embodiment, the process flow 400 described hereinafter may tailor the mineral and/or fat profile of the MCC by controlling the amount of carbon dioxide source (e.g., gaseous CO₂) from the carbon dioxide supply unit 120 and the amount of fat from the fat supply unit 124 as shown in FIG. 1G.

In step 412, a fat source from the fat source is mixed with at least a portion of the modified MCC to form a fat modified MCC.

The herein described subject matter sometimes illustrates different components contained within, or connected with, other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “connected”, or “coupled”, to each other to achieve the desired functionality, and any two components capable of being so associated can also be viewed as being “couplable”, to each other to achieve the desired functionality.

It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes. Furthermore, it is to be understood that the invention is defined by the appended claims.

1. A method for forming a modified micellar casein concentrate comprising:
providing a volume of skim milk;
performing a first filtration process on the volume of skim milk to form a micellar casein concentrate;
mixing carbon dioxide with at least a portion of the micellar casein concentrate to solubilize one or more components of the micellar casein concentrate; and
performing an additional filtration process on the mixture of carbon dioxide and micellar casein concentrate to remove at least a portion of the one or more solubilized components of the micellar casein concentrate to form a modified micellar casein concentrate.

2. The method of claim 1, wherein the volume of skim milk comprises a volume of pasteurized skim milk.

3. The method of claim 1, wherein the performing a first filtration process on the volume of skim milk to form a micellar casein concentrate comprises:
performing a microfiltration process on the volume of skim milk to form a micellar casein concentrate

4. The method of claim 1, wherein the mixing carbon dioxide with at least a portion of the micellar casein concentrate to solubilize one or more components of the micellar casein concentrate comprises:
transforming the one or more components of the micellar casein concentrate from a colloidal phase to a serum phase.

5. The method of claim 1, wherein the one or more components of the micellar casein concentrate comprise one or more minerals, wherein the one or more minerals comprise calcium phosphate.

6. (canceled)

7. The method of claim 1, wherein the performing an additional filtration process on the mixture of carbon dioxide and micellar casein concentrate to remove at least a portion of the one or more solubilized components of the micellar casein concentrate to form a modified micellar casein concentrate comprises:
performing an ultrafiltration process on the mixture of carbon dioxide and micellar casein concentrate.

8. The method of claim 1, wherein the modified micellar casein concentrate comprises a mineral-reduced micellar casein concentrate, wherein a mineral reduction range of the mineral-reduced micellar casein concentrate is between 5% and 40%.

9. (canceled)

10. (canceled)

11. The method of claim 1, further comprising:
concentrating the modified micellar casein concentrate to provide a concentrated modified micellar casein concentrate.

12. (canceled)

13. The method of claim 1, wherein the performing an additional filtration process on the mixture of carbon dioxide and micellar casein concentrate to remove at least a portion of the one or more solubilized components of the micellar casein concentrate to form modified micellar casein concentrate comprises:
performing an additional filtration process on the mixture of carbon dioxide and micellar casein concentrate while mixing additional carbon dioxide with the mixture of carbon dioxide and micellar casein concentrate.

14. A method for forming a fat modified micellar casein concentrate comprising:
providing a volume of skim milk;
performing a first filtration process on the volume of skim milk to form a micellar casein concentrate;
providing a fat source;
mixing carbon dioxide with at least a portion of the micellar casein concentrate to solubilize one or more components of the micellar casein concentrate; and
performing an additional filtration process on the mixture of carbon dioxide, micellar casein concentrate, and a fat from the fat source to remove at least a portion of the one or more solubilized components of the micellar casein concentrate to form a fat modified micellar casein concentrate.

15. The method of claim 14, wherein the volume of skim milk comprises a volume of pasteurized skim milk.

16. The method of claim 14, wherein the one or more components of the micellar casein concentrate comprise one or more minerals, wherein the one or more minerals comprise calcium phosphate.

17. (canceled)

18. The method of claim 14, wherein the performing a first filtration process on the volume of skim milk to form a micellar casein concentrate comprises:
performing a microfiltration process on the volume of skim milk to form a micellar casein concentrate

19. The method of claim 14, wherein the performing an additional filtration process on the mixture of carbon dioxide, micellar casein concentrate, and a fat from the fat source to remove at least a portion of the one or more solubilized components of the micellar casein concentrate to form a fat modified micellar casein concentrate comprises:
performing an ultrafiltration process on the mixture of carbon dioxide, micellar casein concentrate, and a fat from the fat source.

20. The method of claim 14, wherein the mixing carbon dioxide with at least a portion of the micellar casein concentrate to solubilize one or more components of the micellar casein concentrate comprises:
transforming the one or more components of the micellar casein concentrate from a colloidal phase to a serum phase.

21. The method of claim 14, wherein the fat modified micellar casein concentrate comprises a fat-modified mineral-reduced micellar casein concentrate, wherein a mineral reduction range of the mineral-reduced micellar casein concentrate is between 5% and 40%.

22. (canceled)

23. (canceled)

24. (canceled)

25. (canceled)

26. The method of claim 14, wherein the performing an additional filtration process on the mixture of carbon dioxide, micellar casein concentrate, and a fat from the fat source to remove at least a portion of the one or more solubilized components of the micellar casein concentrate to form a fat modified micellar casein concentrate comprises:
performing an additional filtration process on the mixture of carbon dioxide, micellar casein concentrate, and a fat from the fat source while mixing additional carbon dioxide with the mixture of carbon dioxide, micellar casein concentrate, and the fat from the fat source.

27. (canceled)

28. (canceled)

29. The method of claim 28, wherein the performing an additional filtration process on the mixture of carbon dioxide, micellar casein concentrate, and a fat from the fat source to remove at least a portion of the one or more solubilized components of the micellar casein concentrate to form a fat modified micellar casein concentrate comprises:
performing an additional filtration process on the mixture of carbon dioxide, micellar casein concentrate, and a fat from the fat source while mixing additional carbon dioxide with the mixture of carbon dioxide, micellar casein concentrate, and fat.

30. The method of claim 28, further comprising:
prior to mixing carbon dioxide with at least a portion of the micellar casein concentrate, holding a mixture of micellar casein concentrate and fat in a tank.

31. (canceled)

32. (canceled)

33. (canceled)

34. A method for forming a fat modified micellar casein concentrate comprising:
providing a volume of skim milk;
performing a first filtration process on the volume of skim milk to form a micellar casein concentrate;
mixing carbon dioxide with at least a portion of the micellar casein concentrate to solubilize one or more components of the micellar casein concentrate;
performing an additional first filtration process on the mixture of carbon dioxide and micellar casein concentrate to remove at least a portion of the one or more solubilized components of the micellar casein concentrate to form a modified micellar casein concentrate;
providing a fat source; and
mixing a fat from the fat source with at least a portion of the modified micellar casein concentrate to form a fat modified micellar casein concentrate.

35. (canceled)

36. (canceled)

37. (canceled)

38. (canceled)

39. (canceled)

40. (canceled)

41. (canceled)

42. (canceled)

43. (canceled)

44. (canceled)

45. (canceled)

46. (canceled)

47. (canceled)

48. (canceled)

49. (canceled)

50. (canceled)

51. (canceled)

52. (canceled)

53. (canceled)

54. (canceled)

55. (canceled)

56. (canceled)
